(19) United States
(12) Patent Application Publication
(10) Pub. No.: US 2016/0004715 A1
(43) Pub. Date: Jan. 7, 2016

(54) Minimizing Metadata Representation In A Compressed Storage System

(71) Applicant: International Business Machines Corporation, Armonk, NY (US)

(72) Inventors: Jonathan Amit, Omer (IL); David D. Chambliss, Morgan Hill, CA (US); M. Corneliu Constantinescu, San Jose, CA (US)

(73) Assignee: International Business Machines Corporation, Armonk, NY (US)

(21) Appl. No.: 14/321,981

(22) Filed: Jul. 2, 2014

(51) Int. Cl. G06F 17/30

(52) U.S. Cl. CPC G06F 17/30153; G06F 17/30138

(57) ABSTRACT

Embodiments of the invention relate to compressed storage systems, and reducing metadata representing compressed data. Compressed data is stored in units referred to as partitions, with each partition having a header that contains a virtual address of data stored in the partition. A linear function is providing to represent a mapping between a virtual address segment and a compressed data extent, with a slope of the function representing an associated compression ratio. A read operation is supported by consulting the mapping and using the mapping to locate the corresponding compressed extent. Similarly, a write operation is supported by writing a new segment, compressing content in the segment, and computing a new mapping of the compressed segment metadata in memory. The new mapping is represented in the linear function.

### BACKGROUND

The present invention relates to mitigation of metadata representation of compressed data in a primary storage system. More specifically, the invention relates to a piecewise continuous function representing a mapping between a virtual address segment and a compressed data extent.

Compression enabled primary storage system use on disk metadata to map between raw and compressed data space. In one embodiment, the metadata is in the form of a B-tree and is stored on disk. The metadata functions as a layer on disk. For random accesses to compressed data to support a read request, this additional layers slows down the time for processing the request. There is a similar delay in processing write requests as well. The metadata layer generally represents a percentage of the size of the data stored in the associated storage system. In a large storage system, such as a hundred terabyte system, the size of the metadata increases significantly and may occupy a few terabytes of space. So, in addition to extending processing time, the metadata layer may also occupy a significant amount of storage space.

The metadata layer may be architecturally configured to be stored on flash storage, which is a block level mapping of the metadata. However, this metadata layer would compete for flash space with other types of metadata, such as thin provisioning, file system, etc. Accordingly, configuring the metadata layer for flash storage only serves to support the need to minimize the metadata needed for representing compressed data in primary storage systems.

### SUMMARY

The invention includes a method, computer program product, and system for minimizing metadata representation in a primary storage system.

A method, computer program product, and system are provided to support and enable mitigated metadata representation of compressed data. A processing unit is operatively coupled to a persistent storage device, and partition compression units are stored local to the storage device. Each partition is a set of compressed data, and each partition is provided with a header that contains a virtual address of data in the partition. A linear function representing a mapping between a virtual address segment and a compressed data extent is provided. In response to a read operation, the function is consulted and a compressed data block is located and de-compressed from the mapping. Similarly, in response to a write operation, content of a new segment is compressed, a new mapping of compressed metadata is computed, and at least one candidate location is found. The linear function is updated based on the placement location of the new segment.

### BRIEF DESCRIPTION OF THE SEVERAL VIEWS OF THE DRAWINGS

The drawings reference herein form a part of the specification. Features shown in the drawings are meant as illustrative of only some embodiments of the invention, and not of all embodiments of the invention unless otherwise explicitly indicated.

FIG. 1 depicts a block diagram illustrating a logical system diagram.

FIG. 2 depicts a flow chart illustrating a process for supporting a read operation.

FIG. 3 depicts a graph illustrating a sample mapping.

FIG. 4 depicts a flow chart illustrating a process for supporting a write operation.

FIG. 5 depicts a flow chart illustrating a process for a sub-segment update operation.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Data is compressed in small independent units referred to herein as partitions. In one embodiment, the size of each partition ranges from 8 KB to 64 KB. Each partition is configured with a header containing the uncompressed address of the partition, also referred to herein as a virtual address. In one embodiment, the header can be inside each partition. Similarly, in one embodiment, the header can be outside the partition and function as a table of contents shared by a group of partitions. In one embodiment, the header is stored in cache. The virtual address space in a block storage device is divided into a plurality of segments. In one embodiment, each segment may be a fixed size, e.g. 10 GB each. The segments are further divided into sub-segments, which are employed as a basic unit for piecewise linear mapping. The physical address space is divided into sections referred to herein as extents. In one embodiment, the extents may be a fixed size with one segment associated with one extent. Similarly, in one embodiment, the metadata representing an associated extent may be reduced by one segment sharing two or more extents. The aspect of virtualization maps each sub-segment into a contiguous range within an extent. In one embodiment, the range is referred to as a sub-extent.

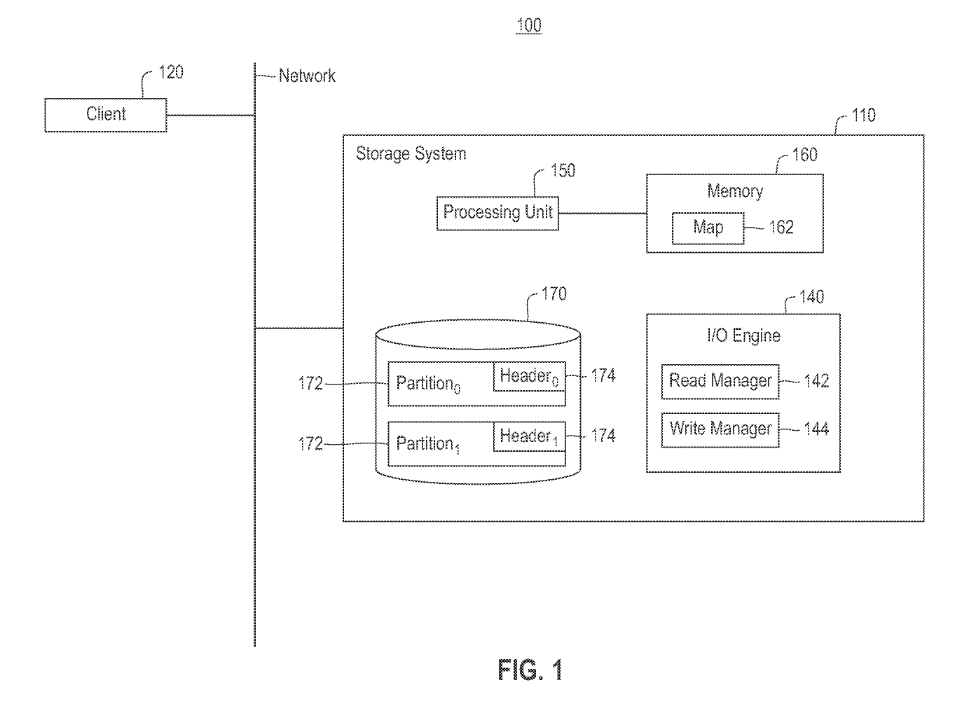

With reference to FIG. 1, a logical system diagram (100) is provided. Specifically, a storage system (110) is provided in communication with one or more storage clients (120). The storage system (110) has an I/O engine (140), a processing unit (150), memory (160), and data storage (170). The storage system (110) supports read and write operations for the storage clients (120). Data storage (170), also referred to herein as a persistent storage device, is employed to store one or more partition compression units, also referred to herein as partitions (172). Each of the partitions (172) includes a header (174) that contains a virtual address of data stored in the partition. A map (162) of expected location and margins of an address space associated with logical capacity is stored in memory (160). The map (162) includes a linear function, a spline, or any piece wise continuous function, representing a mapping between a virtual address segment and a compressed data extent.

The I/O engine (140) includes a read manager (142) to support a read operation, and a write manager (144) to support a write operation. In response to receipt of a read operation by the I/O engine (140), the read manager (142) consults the linear function in the map (162), and from the map computes a physical address neighborhood containing the requested data. In one embodiment, the physical address neighborhood is larger than the compressed extent that contains the requested data. The read manager (142) reads content of the physical address neighborhood, locates a compressed data block in the read content, de-compresses the compressed block, and returns the requested data to the storage client (120) in a de-compressed format. Similarly, in response to receipt of a write operation by the I/O engine (140), the write manager (144) writes a new data segment. More specifically, the write manager (144) compresses all content in the new data segment, computes a new mapping of the compressed segment metadata in the memory (160), and determines at least one candidate write location for the new segment. The new mapping may be mutable, to accommodate the new segment, or immutable. With respect to the new segment and a mutable mapping, the write manager (144) assesses the linear function, and if there is a difference in the slope, the write manager (144) places a knot in the linear function, with the knot characterizing the change in the slope for the new mapping.

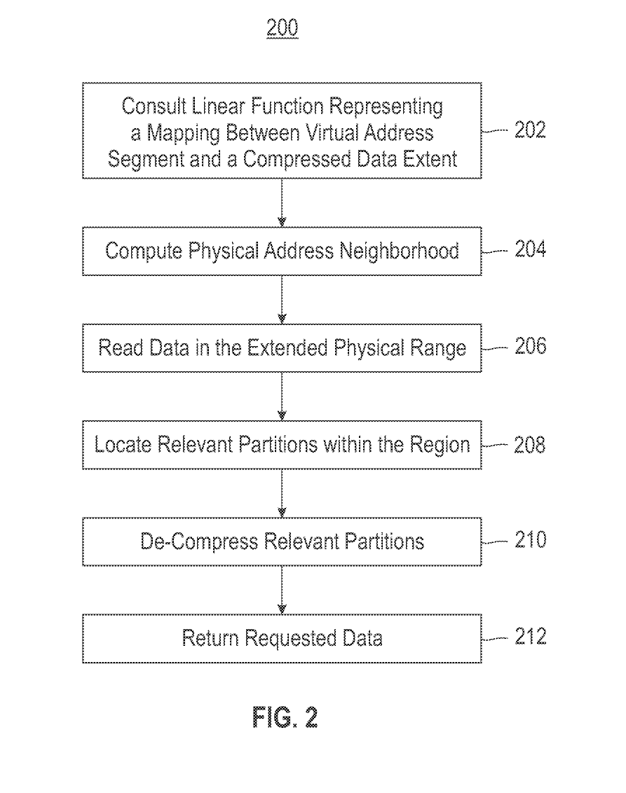

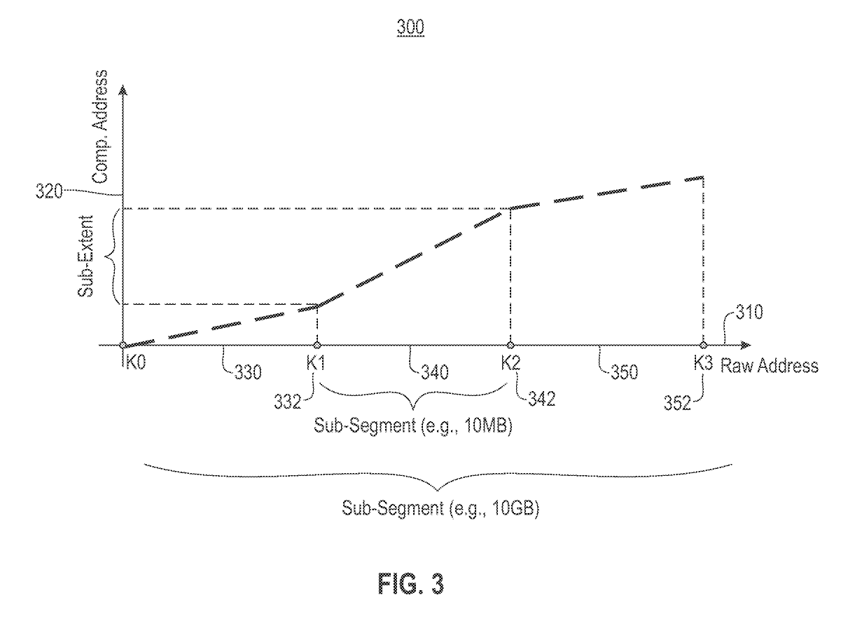

A virtualization layer is structured to reduce the metadata size. The partitions are written in accordance with a linear approximate mapping. More specifically, the data for a given range of virtual addresses, called a sub-segment, is written so that the nominal location in the physical storage is a linear function of the virtual address. In one embodiment, the mapping is approximate and the compressed partitions may be placed within a known margin of a nominal location. An example of the mapping is shown and described in FIG. 3, below. Referring to FIG. 2, a flow chart (200) is provided for a read operation. In response to receipt of the read operation, a linear function representing a mapping between a virtual address segment and a compressed data extent is consulted (202). In one embodiment, the mapping is a linear function. Similarly, in one embodiment, the mapping is a spline or any piece wise continuous function. A physical address neighborhood that is larger than the compressed extent that contains the requested data is computed (204), e.g. the range of the physical address is extended by a margin. A physical read of the data in the extended physical range is performed (206), and relevant partitions, e.g. compression units, within the region are located (208). In one embodiment, the physical read includes determining a starting address of the request in view of the expansion at step (204). To address the expansion, a margin representing the expansion is subtracted from the starting address, with the result of the difference to be used as a start of the physical block address. Similarly, in one embodiment, the margin is added to an expected ending address of the request, with the result to be used as an end of the physical address neighborhood. Accordingly, responding to the read operation includes determining both the start address and the end address with respect to the margin expansion.

Following step (208), the relevant partitions are de-compressed (210), and the requested data is returned in a de-compressed format (212). The expanded read size as showed at step (204) includes a negligible incremental performance cost, while offering latitude for data units of different compressibilities to be placed according to one linear function.

As discussed above with respect to the read operation, the mapping is a function, and in one embodiment is a linear function. Referring to FIG. 3, a graph (300) is provided illustrating a sample mapping. As shown, the graph is two dimensional with the horizontal axis (310) representing the raw data address, also referred to as the virtual address, and the vertical axis representing the compressed data address (320), also referred to as the physical address. In one embodiment, the axes may be inverted, and as such, the illustration shown herein should not be considered limiting. There are three sub-segments shown herein (330), (340), and (350). In one embodiment, each sub-segment is 10 MB. Each of the sub-segments is shown with a different slope. For each sub-segment, the slope represents a compression ratio between the sub-extent and the sub-segment. Three knots are shown in the representation, including a first knot (332), a second knot (342), and a third knot (352). Each knot represents a point in the linear representation where the slope changes, e.g. the compression ratio changes. In one embodiment, each sub-segment has a different compression ratio, and as such, the knot represents the end point of one sub-segment and the start point of another sub-segment. Data is compressed in independent units referred to herein as partitions. These units are employed for fast random data access. Compressed partitions have header information that contains the virtual address of the uncompressed data in the partition and the size of the compressed partition; compressed partitions are placed in the extents in increasing order of their virtual address to enable finding the relevant compressed partition between other stored partitions. In one embodiment the header information for a number of partitions is stored at fixed intervals (named logical pages) on the storage media (170) as small tables of content for each page describing partition locations within the page, their compressed size, the virtual address of data they represent and also some information on content in neighboring logical pages.

As noted above, the sub-segment mapping metadata, hereinafter referred to as sub-segment mapping, is stored in cache. The sub-segment mapping represents a minimal amount of metadata needed to represent compressed data in the physical storage. The compression ratio of each sub-segment is represented in the sub-segment mapping. Each knot in the linear mapping is named in an associated data structure holding the stored interpolation information. Each knot entry in the data structure includes: an extent identifier, an extent offset, and a sub-segment slope. In one embodiment, the metadata of the knot entry is about 5 bytes per knot. Accordingly, data inherent to each knot is represented in the header.

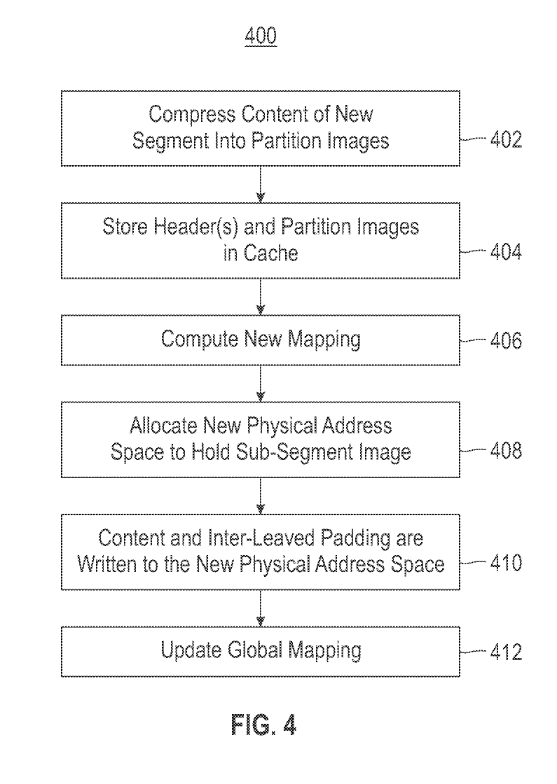

Referring to FIG. 4, a flow chart (400) is provided illustrating the process of a write operation. Data write operations involve complexity because of the need to adhere to the mapping function. More specifically, the mapping is created and adjusted in response to actual compressibility of data partitions and the physical device space they need to occupy. In one embodiment, an updated version of data at a specific address may fit in the same location. In another embodiment, a group of neighboring partitions are rewritten in one or more shifted address to make space available for the write data. In another embodiment, an entire range of data is written to a new location, and the mapping is changed accordingly. The steps shown in FIG. 4 are based on the pre-condition that no prior data needs to be preserved with respect to the new write operation. As such, the write operation will write sequentially or randomly. The sequential write will overwrite an entire sub-segment address range, and the random write will write new data into part or all of an unused sub-segment. All of the content of the new segment is compressed into partition images (402). The header(s) for the partition images and the partition images are stored in cache memory (404). A new tentative mapping of the metadata in memory is computed (406). Accordingly, prior to completion of the write operation, the tentative mapping is created as a representation between the raw data and the compressed data associated with the write operation.

The write operation may result in maintaining the associated data as a unit, e.g. full sub-segment, or in one embodiment, may result in scattering the associated data within the physical space. When the data is scattered, an excessive quantity of indirection records and/or excessive padding may results. In another embodiment, mapping of the metadata to the physical space may be immutable or mutable. A mutable mapping is subject to change compatible with locations of data already in the physical storage. In one embodiment, with respect to mutable mapping, adjustments are made as new data arrives that is more or less compressible than predicted. The slope of the function represents the compressibility of the sub-segment. As the mutable mapping is amended, the slope of the function may change, and associated knots in the slope representation may be inserted or moved. In one embodiment, the mutable mapping is used for progressive sequential write operations into a new sub-segment, e.g. the sequential writes are concatenated. Similarly, in one embodiment, the mutable mapping is used when additional bytes are needed to express constraints from already written content.

An immutable mapping is not subject to change. The immutable mapping may be used for almost all sub-segments. In one embodiment, the immutable mapping is about 10 bytes per sub-segment. The immutable mapping may be made mutable in some circumstances, such as a case of a sub-segment tail overwrite. In one embodiment, spare bytes between adjacent partitions, e.g. padding, or the addition of knots into the linear representation may be incorporated into the new tentative mapping. Similarly, in one embodiment, the mapping might be mutable, e.g. subject to change, depending on the compressibility of the partition. Accordingly, the tentative mapping at step (406) accounts for the compressibility of the partition.

Following step (406) new physical address space, e.g. a new sub-extent, corresponding to the virtual address space is allocated to hold the image of the sub-segment (408). Both content and any inter-leaved padding are written to the new physical address space in accordance with the tentative mapping (410). In addition, once the new mapping has been committed, a global mapping is updated with the new mapping (412). The global mapping is an in-memory continuous map of expected location and margins for an address spaced associated with the logical capacity. Accordingly, the process shown herein demonstrates a new sub-segment write operation and the interface of the new write with the continuous map.

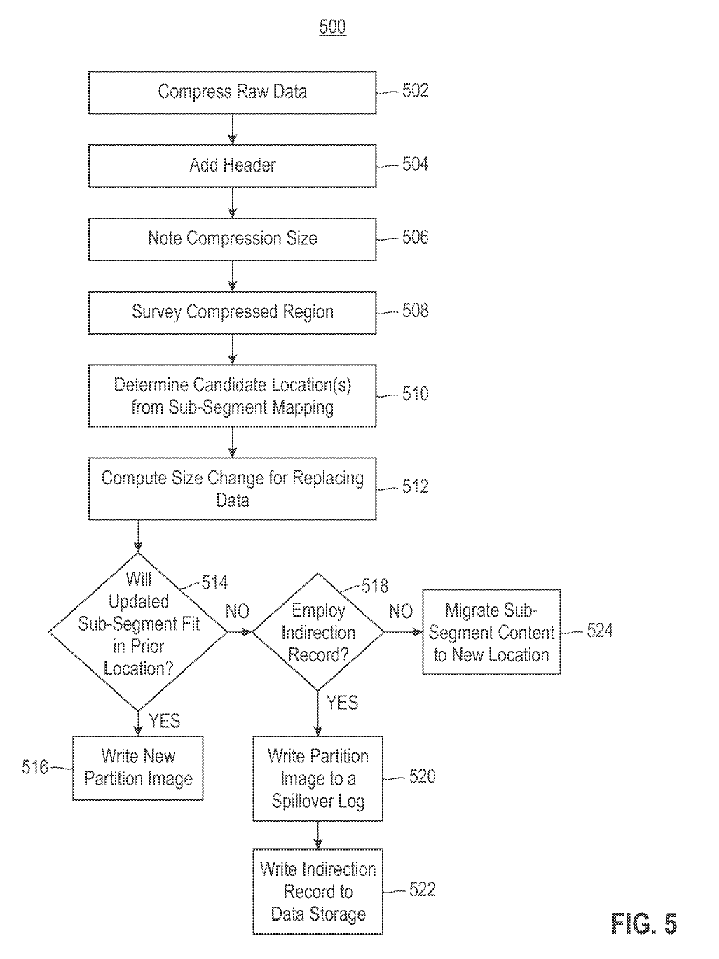

Referring to FIG. 5, a flow chart (500) is provided demonstrating a process for a sub-segment update operation. This process is associated with the situation where one or more writes are available for a sub-segment, but some data that was previously written needs to be preserved. The raw data for the new write is compressed (502), a header is added (504), and the compression size is noted (506). A survey is then performed of a region, e.g. a compressed region, where the new data may be placed (508). One or more candidate write locations are determined from the sub-segment mapping (510). In addition, the size change from replacing old data with new data is computed (512). It is then determined if the sub-segment with the updated data will fit in the prior location (514). If at step (514) it is determined that the updated sub-segment will fit in the prior location, then the new partition image is written (516). In one embodiment, the new partition image includes padding with shifted rewrites of existing data. However, if at step (514) it is determined that the updated sub-segment will not fit in the prior location, then it is determined if an indirection record will be employed (518). Use of the indirection record includes writing the partition image to a spillover log (520) and writing the indirection record to data storage (522) to provide a record of the moved location of the write data. However, if the indication is not going to be used, the sub-segment content is migrated to a new location (524), including reading any prior data which is not to be overwritten, and merging old and new data and handling the merged data as a new sub-segment write. Following the completion of steps (522) or (524), the old sub-segment is marked as free space. Accordingly, a sub-segment of data may be updated with a write operation.

In one embodiment, to facilitate the update operation, free space is provided during the write operation when the initial compression of the partition takes place. Free space may be employed by relaxing the estimated compression ratio, also referred to here as a slope of the function, when the partition is initially written. Similarly, in one embodiment, a constant amount of free space is left with the partition. In some embodiments, the free space is zeroed so that it is subject to detection when one or more compressed partitions are subject to a read operation. Similarly, the header of the compressed partitions contains the raw address of the free space so that they can be located in a read window.

As data is written, compressed partitions are initially placed into extents for various scenarios, including sequential, quasi-sequential, and random. The goal for data placement is to maintain a readable linear interpolation. For a sequential write, knots, as described above, are used to indicate a change in the interpolation slope or error-window, or to reflect a change in the target sub-extent. Similarly, for a quasi-sequential write, a redirection record is placed on disk and written to a location on a different extent than the one used in current sub-segment mapping. The redirection record does not require additional memory metadata, but will require an additional read access. For a random write, an entire sub-segment is written to a new location.

The mapping between the segments and the extents, e.g. between the raw data and the compressed data, is a non-complex representation of the mapping that provides locality in compressibility of data. The slope of the linear representation provides reliability for predicting the compression ratio. A compression ratio between an extent and the associated segment may be predicted with the slope of the function. In one embodiment, the slope enables placement of a non-sequential compressed partition. Similarly, in one embodiment, a sequence of disk sectors may be copied from one location to another location to maintain the linear mapping in response to a sub-set of partitions with a significantly different compression ratio than the others in the segment.

The system described above in FIG. 1 has been labeled with tools in the form of a read manager and a write manager. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of representation of data compression as a linear mapping lowers metadata in compressed storage system.

### Alternative Embodiment

It will be appreciated that, although specific embodiments of the invention have been described herein for purposes of illustration, various modifications may be made without departing from the spirit and scope of the invention. In particular, each segment may be dynamically assigned a limited number of extents into which the segment's data may be stored. An extent may be owned by one segment, or a quantity of segments may use different parts of the same extent. Similarly, in one embodiment, the slope of the map function may represent an average compression ratio of a plurality of segments. Accordingly, the scope of protection of this invention is limited only by the following claims and their equivalents.

We claim:

1. A method for minimizing metadata representing compressed data, comprising:
operatively coupling a processing unit to memory and a persistent storage device;
the persistent device including a plurality of partition compression units, each partition being a set of compressed data, the partitions each having a header containing a virtual address of data in the partition;
servicing a read request, including:
consulting a linear function representing a mapping between a virtual address segment and a compressed data extent; and
from the mapping, computing a physical address neighborhood larger than the compressed extent containing requested data, reading content of the physical address neighborhood, locating a compressed data block in the read content; de-compressing the compressed data block, and returning the requested data in a de-compressed format.

2. The method of claim 1, wherein consulting the linear function includes extending a range of nominal locations for the compressed extent by a margin amount, determining an expected location of a starting address of the request, subtracting the margin, and using a result as a start of the physical block address.

3. The method of claim 2, further comprising determining an expected ending address of the request, adding the margin, and using a result as an end of the physical address neighborhood.

4. The method of claim 1, further comprising an in-memory continuous map of expected locations and margins for an address space associated with the logical capacity.

5. The method of claim 1, further comprising predicting a compression ratio between the extent and the segment with a slope of the linear function.

6. The method of claim 2, further comprising constructing a linear interpolation of a set of adjacent compressed data units, and placing a knot in the interpolation where the slope changes.

7. The method of claim 1, further comprising relaxing an estimated compression ratio, including leaving free space around a compressed partition.

8. The method of claim 1, further comprising reducing metadata representing the extent, including one segment sharing two or more extents.

9. The method of claim 1, further comprising writing a new segment, including compressing all content in the new segment, computing a new mapping of the compressed segment metadata in the memory.

10. The method of claim 8, determining one or more candidate write locations for the new segment, wherein the new mapping is mutable to accommodate the new segment, including a knot in the linear function characterizing the slope responsive to the new mapping.

11. The method of claim 10, wherein the new mapping is immutable.

12. A computer program product for minimizing metadata representation of compressed data, the computer program product comprising a computer readable storage device having program code embodied therewith, the program code executable by a processing unit to:
operatively couple a processing unit to memory and a persistent storage device;
the persistent device including a plurality of partition compression units, each partition being a set of compressed data, the partitions each having a header containing a virtual address of data in the partition;
service a read request, including:
consult a linear function representing a mapping between a virtual address segment and a compressed data extent; and
from the mapping, compute a physical address neighborhood larger than the compressed extent containing requested data, read content of the physical address neighborhood, locate a compressed data block in the read content; de-compress the compressed data block, and return the requested data in a de-compressed format.

13. The computer program product of claim 12, wherein the program code to consult the linear function includes code to extend a range of nominal locations for the compressed extent by a margin amount, determine an expected location of a starting address of the request, subtract the margin, and use a result as a start of the physical block address.

14. The computer program product of claim 13, further comprising program code to determine an expected ending address of the request, adding the margin, and using a result as an end of the physical address neighborhood.

15. The computer program product of claim 12, further comprising program code to predict a compression ratio between the extent and the segment with a slope of the linear function.

16. The computer program product of claim 13, further comprising program code to construct a linear interpolation of a set of adjacent compressed data units, and place a knot in the interpolation where the slope changes.

17. The computer program product of claim 12, further comprising program code to relax an estimated compression ratio, including leave free space around a compressed partition.

18. The computer program product of claim 12, further comprising program code to determine one or more candidate write locations for a new segment, wherein a new mapping is mutable to accommodate the new segment, including a knot in the linear function characterizing the slope responsive to the new mapping.

19. The computer program product of claim 18, wherein the new mapping is immutable.

20. A system comprising:
a storage system, including a server having processing unit operatively coupled to memory, the server in communication with an I/O engine, and at least one persistent storage device;
the persistent device including a plurality of partition compression units, each partition being a set of compressed data, the partition units each having a header containing a virtual address of data in the partition; and
the I/O engine having a manager to support an I/O operation, the manager having functionality including:
consultation of a linear function representing a mapping between a virtual address segment and a compressed data extent; and
from the mapping, computation of a physical address neighborhood larger than the compressed extent containing requested data, read content of the physical address neighborhood, locate a compressed data block in the read content; de-compress the compressed data block, and return the requested data in a de-compressed format.
